(19) United States
(12) Patent Application Publication
(10) Pub. No.: US 2008/0118686 A1
(43) Pub. Date: May 22, 2008

(54) INJECTION BLOW MOLDING PROCESS AND ARTICLE

(76) Inventors: Katherine Glasgow, Evansville, IN (US); Vincent L. Lanning, Pittsfield, MA (US); Michael K. Pilliod, Schenectady, NY (US)

Correspondence Address: SABIC - 08CT;SABIC Innovative Plastics - IP Legal, ONE PLASTICS AVENUE, PITTSFIELD, MA, 01201-3697, US

(21) Appl. No.: 11/561,427

(22) Filed: Nov. 20, 2006

(51) Int. Cl. B29D 22/00

(52) U.S. Cl. 428/35.7; 264/513

(57) ABSTRACT

Various embodiments of a process for making hollow thermoplastic articles are provided. In one embodiment, a process for producing hollow thermoplastic article includes placing a sock preform of a first polymer composition about a core pin and injection molding a molten parison of a second polymer composition that is different than the first polymer composition into an injection mold cavity and onto the sock perform. The injection molding process produces an injection preform having two different material compositions. The process further include blow molding the injection preform to produce a hollow thermoplastic article having an interior surface of the first polymer composition and an exterior surface of the second polymer composition.

### FIELD OF THE INVENTION

This invention relates to a blow molded thermoplastic article and a process for making the article. More particularly, the invention relates to an injection blow molded article that has at least two thermoplastic layers of materials that are different and a process for making the article.

### BACKGROUND OF THE INVENTION

Hollow thermoplastic articles, such as containers, bottles, vials, etc., are typically produced by injection blow molding processes. A conventional injection blow molding process usually includes three main stages of processing, namely, injection molding, blow molding, and ejection. Generally in the first stage, a molten polymer parison is injected onto a core pin that is placed between a top and a bottom injection mold during the first stage to produce a preform. Then in the second stage, the preform is placed between a top and bottom blow mold and gas is injected into the preform through the core pin to produce a hollowed thermoplastic article. Finally, the hollow thermoplastic article is ejected from the core pin.

Hollow thermoplastic articles made via the injection blow molding process have the same material composition at the internal and external surfaces of the article. When a molten polymer is injected through a nozzle into the cavity of the injection mold, material sets up on the inside surfaces of the mold cavity and also on the surface of the core pin which is disposed between the upper and lower mold cavities. The polymer surrounding the core pin eventually becomes the inner layer of the hollow article, and the layer of polymer surrounding the mold cavity surfaces, eventually becomes the outer layer of the hollow article.

Co-injection blow molding processes which employ two or more materials in the injection stage of the process are also well known. For example, two different materials can be melted in separate injection barrels and flow through separate runner systems to the mold. Hollow thermoplastic articles used in the packaging industry benefit greatly by the co-injection process. For example, bottles made for beverage have two or more layers of materials, at least one of which is a gas barrier layer sandwiched between two or more layers having material compositions different than the barrier layer. However, the co-injection process also results in hollow thermoplastic articles that have the same material composition at the internal surface and external surfaces of the article when the injection blow molding process is complete. When a second molten polymer is injected, it flows between the layers formed by the first polymer around the core pin and the mold cavities, and the second polymer becomes a middle layer.

The material properties of the internal and external surfaces of hollow thermoplastic articles, also known as “surface technology” has become increasingly important in several industries. For example, in the healthcare industry, it is often desirable that the internal surface of containers that carry fluids such as, aqueous fluids of pharmaceuticals, or bodily fluids, possess characteristic that are different than the external surface of the container. More specifically, materials which exhibit hydrophobic behavior can prevent water in aqueous solutions from wetting or adhering to the inside surface of the container, thereby ensuring that the concentration of a pharmaceutical dosage maintains consistent. Materials which exhibit hydrophilic behavior can prevent adhesion of proteins to the inside surface of the container. In another example, materials that are hemo-compatible can help prevent platelets of blood from adhering to the surface of the container. Alternatively, a chemically resistant material can be chosen as the interior surface of the container. The material can be specifically chosen to either bind or resist a specific chemical of interest.

In other applications, surface technology can play an important role in aesthetics, for example, where two or more colors are used throughout the part. Therefore, it is desirable to produce a hollow thermoplastic article that has internal and external layers of different material compositions, while utilizing the productivity advantages offered by the injection blow molding process.

### SUMMARY OF THE INVENTION

The present invention provides for an injection blow molding process for producing a hollow thermoplastic article having at least two layers, an inner layer and an outer layer, each having a material composition that is different.

In one embodiment of the invention, the process for making a hollow thermoplastic article including the steps of placing a sock preform of a first polymer composition about a core pin, injection molding a molten parison of a second polymer composition which is different than the first polymer composition about the sock preform to produce an injection preform having two different material compositions, and blow molding the injection preform to produce a hollow thermoplastic article having an interior surface of the first polymer composition and an exterior surface of the second polymer composition. In another embodiment, the process further includes ejecting the hollow thermoplastic article from the core pin after the blow-molding step.

In another embodiment, the invention provides for a process for making a plurality of hollow thermoplastic articles where at least a portion of each step is carried out simultaneously. A plurality of hollow thermoplastic articles are made by placing a sock preform of a first material composition onto a first core pin, and also injection molding a molten parison of a second material composition onto a second core sock of the first material composition, where the second core sock is supported by a second core pin. The process also includes blow molding an injection preform including an inner layer of the first material composition and an outer layer of a second material composition where the injection perform is supported by a third core pin.

### DESCRIPTION OF THE DRAWINGS

The various embodiments of the present invention can be understood with reference of the following drawings. The components are not necessarily to scale. Also, in the drawings, like reference numerals designate corresponding parts throughout the several views.

FIG. 1 is a schematic illustration of an injection blow molding apparatus used in making the injection blow molded article according to an embodiment of the invention;

FIG. 2 is a cross-sectional view of the injection blow molding apparatus taken along lines 2-2 of FIG. 1, showing three stations at which three stages of the process are preformed, according to an embodiment of the invention;

FIG. 3 is an expanded cross-sectional view of an injection preform that includes a “sock” preform and an injection preform about a core rod in the injection molding station of the injection blow molding apparatus of FIG. 2, according to an embodiment of the invention; and

FIG. 4 is a cross-sectional view of a hollow thermoplastic article formed in the blow molding station of the injection blow molding apparatus of FIG. 2, according to an embodiment of the invention.

### DETAILED DESCRIPTION

The present invention is more particularly described in the following description and examples that are intended to be illustrative only since numerous modifications and variations therein will be apparent to those skilled in the art. As used in the specification and in the claims, the term “comprising” may include the embodiments “consisting of” and “consisting essentially of.” All ranges disclosed herein are inclusive of the endpoints and are independently combinable. The endpoints of the ranges and any values disclosed herein are not limited to the precise range or value; they are sufficiently imprecise to include values approximating these ranges and/or values.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. In at least some instances, the approximating language may correspond to the precision of an instrument for measuring the value.

The term “plurality” as used herein refers to a quantity of two or more.

The term “multi-layer” as used herein refers to at least two layers.

The term “different composition” as used herein refers to the different material or polymer compositions. Two material or polymer compositions can be different if their molecular structures are different, their additives are different, or both, where additives include, but are not limited to, fillers, colorants, components which enhance processing and properties, for example.

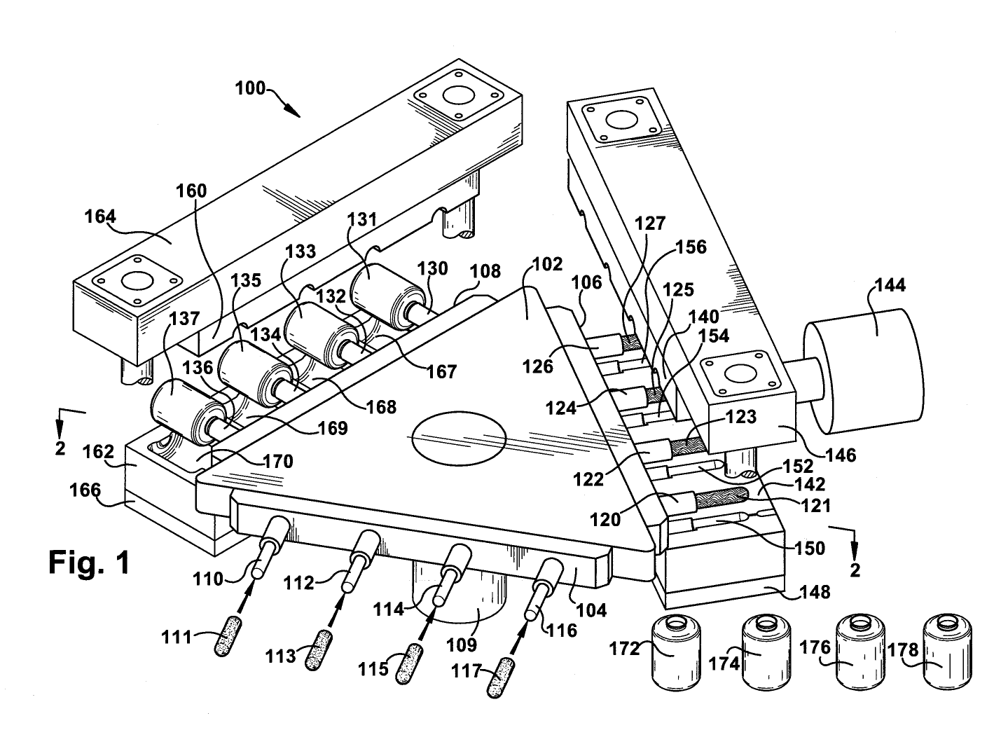

FIG. 1 shows a perspective view of a portion of an injection blow molding apparatus 100 in which a hollow thermoplastic article is produced, according to an embodiment of the present invention. The injection blow molding apparatus includes a triangular turntable 102 that is moved by a rotating shaft 109 at the center of the turntable 102. The turntable 102 as shown has three support walls 104, 106, 108, in a first, second and third position, corresponding to a first station, a second station and a third station, respectively, of the injection blow molding apparatus 100. From each of the support walls extends at least one core pin, for example, core pin 110, 120, and 130. To achieve high productivity rates, injection blow molding apparatus 100 includes a plurality of core pins at each station, for example, a first set of core pins 110, 112, 114 and 116 which protrude from support wall 104 at the first station, a second set of core pins 120, 122, 124, and 126 which protrude from support wall 106 at the second station, and a third set of core pins 130, 132, 134, and 136 which protrude from support wall 108 at the third station.

Injection blow molding apparatus 100 also includes upper and lower injection molds 140 and 142 disposed above and beneath the second set of core pins, and an injection barrel 144 that feeds molten polymer resin to the injection molds in a step of producing the hollow thermoplastic article, as will be further described. The injection molds receive core pins, for example core pins 120, 122, 124 and 126, respectively, which are disposed between a pair of vertically movable mold clamping plates 146 and 148 adjacent the core supporting wall. Upper and lower injection molds 140 and 142 have a plurality of mold cavities, 150, 152, 154, 156 which shape the injection preforms 121, 123, 125 and 127 during the injection molding stage.

Injection blow molding apparatus 100 also includes upper and lower blow molds 160 and 162 that are attached to clamping plates 164 and 166 along side of the third supporting wall 108. The blow molds receive core pins, for example core pins 130, 132, 134 and 136, respectively, that are disposed between a pair of vertically movable mold clamping plates 164 and 166 adjacent the core supporting wall 108. Upper and lower injection molds 140 and 142 have a plurality of mold cavities, 167, 168, 169, 170 which shape the hollow thermoplastic articles 131, 133, 135, and 137 as they are blow molded to a final product.

Hydraulic cylinders (not shown) can be used for opening and closing injection molds 140, 142 and blow molds 160, 162. A driving motor (not shown) can be used for rotating the turntable 102. The support walls 104, 106, 108, and core pins that extend therefrom, reside at each station for the same period of time. The hollow thermoplastic articles 172, 174, 176 and 178, are the result of the process of a previous cycle in a continuous injection blow molding process.

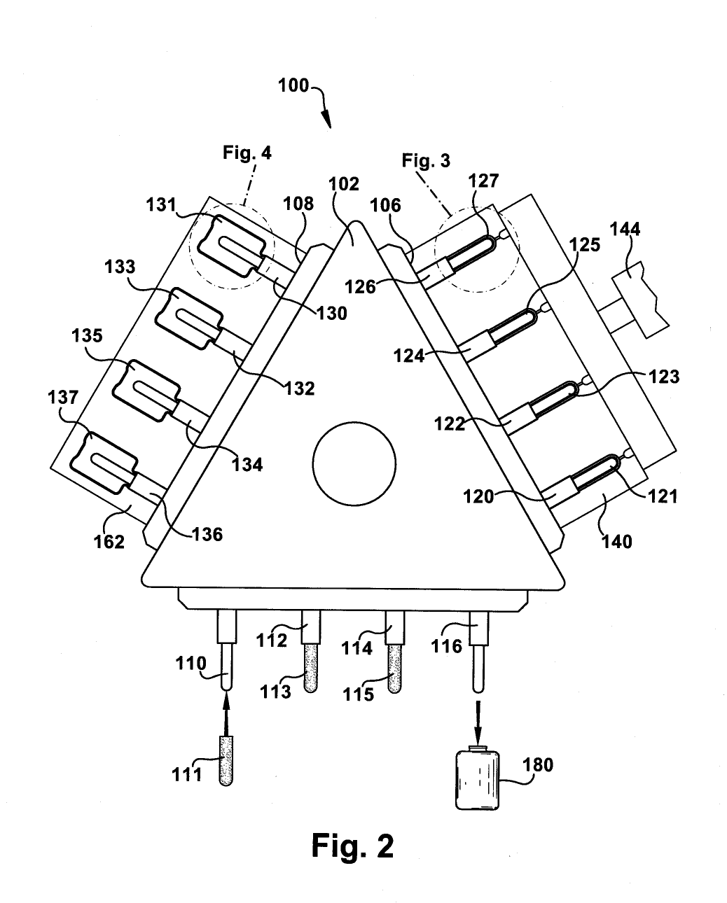

FIG. 2 is a cross-sectional view of the injection blow molding apparatus taken along lines 2-2 of FIG. 1, showing three stations at which hollow thermoplastic articles are made in stages. In one embodiment of the invention, the process for making a hollow thermoplastic article can begin at the first station with placing a sock preform 111 onto core pin 110. As shown, a plurality of sock preforms 111, 113, and 115 can be placed on the plurality of core pins 110, 112, 114, respectively, to produce several hollow thermoplastic articles in one cycle. Next, turntable 102 can be rotated counter-clockwise for approximately 120 degrees on shaft 109 (FIG. 1) to advance the core supporting walls 104, 106, 108 to the subsequent adjacent station of the injection blow molding apparatus 100. Therefore, support wall 104 which supports core pins 110, 112, 114 and 116, and sock preforms 111, 113, 115, and 117 (FIG. 1), respectively, are moved to the second position at the injection molding station, which are shown occupied by injection preforms 121, 123, 125, and 127 positioned on core pins 120, 122, 124, and 126. In a second stage, molten polymer parison having a composition different than the material composition of the sock preforms, or the interior surface of the sock preforms, or both, is injected over the sock preforms to produce injection molded preforms having an inner layer and an outer layer which are a different material composition. The injection preforms may then be released by retracting the injection cylinder 144 (FIG. 1) and opening the injection molds 140 and 142 in a vertical direction.

At the appropriate time, turntable 102 is then rotated counter-clockwise again for approximately 120 degrees, about shaft 109 to advance the core supporting walls 104, 106, 108. Wall 104 is advanced to the adjacent third station in the position shown by that of supporting wall 108 of FIGS. 1 and 2. Support wall 104 and core pins 110, 112, 114 and 116, which support injection preforms and are moved to the third position at the blow molding station, as shown occupied by core pins 130, 132, 134 and 136 which support the completed hollow thermoplastic articles 131, 133, 135 and 137. In the third stage, a gas, for example air, is blown through the core pins against the interior surfaces of the injection preforms, or both, while the injection preforms take shape against blow mold cavities 167, 168, 169 and 170 (FIG. 1). Hollow thermoplastic articles 131, 133, 135, and 137 are therefore produced, each having an inner layer and an outer layer which are a different material composition.

Therefore, in a continuous process, at least a portion of each of the steps of loading, injection molding, and blow molding is carried out simultaneously. At the first station a sock preform 111 of a first material is loaded onto a first core pin 110, at the second station a molten parison of a second material composition is injection molded onto a second core sock to produce an injection perform 121 supported by a second core pin 120, and at a third station an injection perform having an inner layer of the first material composition and an outer layer of the second material composition is blow molded to produce a hollow thermoplastic article 137 supported by a third ore pin 136.

Still referring to FIG. 2, turntable 102 can then be rotated counter-clockwise a third time for approximately 120 degrees, to advance the core supporting walls 104, 106, 108 back to their original positions. Wall 104 is advanced to the first station for the loading of another set of sock preforms to start the process cycle again. Also, shown alongside support wall 104, there is a completed hollow thermoplastic article 180, for example a bottle, being ejected off core pin 116 and away from the injection molding apparatus 100. Blow molded article 180 that previously occupied a position at the third blow molding station is ejected at the first station where a sock preform that has become the inner layer was loaded. Thus, at the first station alongside support wall 104, preform socks are loaded onto core pins 110, 112, 114, and 116, and finished hollow articles, for example, bottle 180 are ejected from the core pins. Thus in another embodiment of the present invention, at least a portion of the ejecting, injection molding, and blow molding steps are carried out simultaneously.

It is not necessary, however, that the hollow thermoplastic articles be ejected at the first station where sock preforms are loaded, and thus, in another embodiment, the hollow thermoplastic articles, for example blow molded articles 131, 133, 135 and 137 can be ejected at the third, blow molding station. In such case, after blow molding is completed, the mold plates 164 and 166 are retreated and the cores are drawn out from the blow molds 160, 162 and the hollow products, can be ejected from the core pins.

In an example of a continuous injection blow molding process, the first core pin 110 after receiving the sock perform 111 including a first material composition can be moved from the first station to a position previously occupied by core pin 120 at the second station; and core pin 120, after a second material composition is injection molded onto the sock perform to produce and injection preform, moves to a station previously occupied by core pin 130 at the third station; and core pin 130 after the blow molding step is complete moves to a position at the first station occupied by core pin 110.

In the load stage, injection molding stage, and blow molding stage described above, one is generally labeled a “stage-limiting step” of the continuous process. The stage-limiting step of the process is the step that requires the most time to complete at the various stations. In a continuous injection blow molding process to produce a hollow articles having a single layer, the steps can include, for example, 1) injecting the molten polymer about the core pin to form a perform at a first station, 2) blow molding the perform to produce the hollow article at a second station, and 3) ejecting the hollow article from the core pin at a third station, the injection molding step is often the stage-limiting step, due to the time needed to cool the injection performs prior to blow molding. Also, in many continuous processes, the ejection stage of the process is the shortest. Therefore, in the process of the present invention described above with respect to FIGS. 1 and 2, the ejection station, at which product is ejected from the core pin is the same station as the loading station, at which sock performs are loaded for the next cycle. That is, the hollow articles produced from the previous cycle can be ejected and new sock performs can be loaded to start the next cycle, at the “eject-load station,” in less time than it takes to complete the injection molding step of the second stage. As one example, the injection molding step may take 10-15 seconds, the blow molding step may take 7-15 seconds, and the ejection and loading steps may each take less than 3 seconds, and the combined ejecting and loading time is equal to or less than the time for each of the injection molding and blow molding steps. In addition, the hollow article produced has at least two distinct layers in which the interior and external surfaces are of different material compositions. Furthermore, the hollow articles having two different material layers are achieved without the need for a whole separate extruder and die set for the injection blow molding apparatus 100.

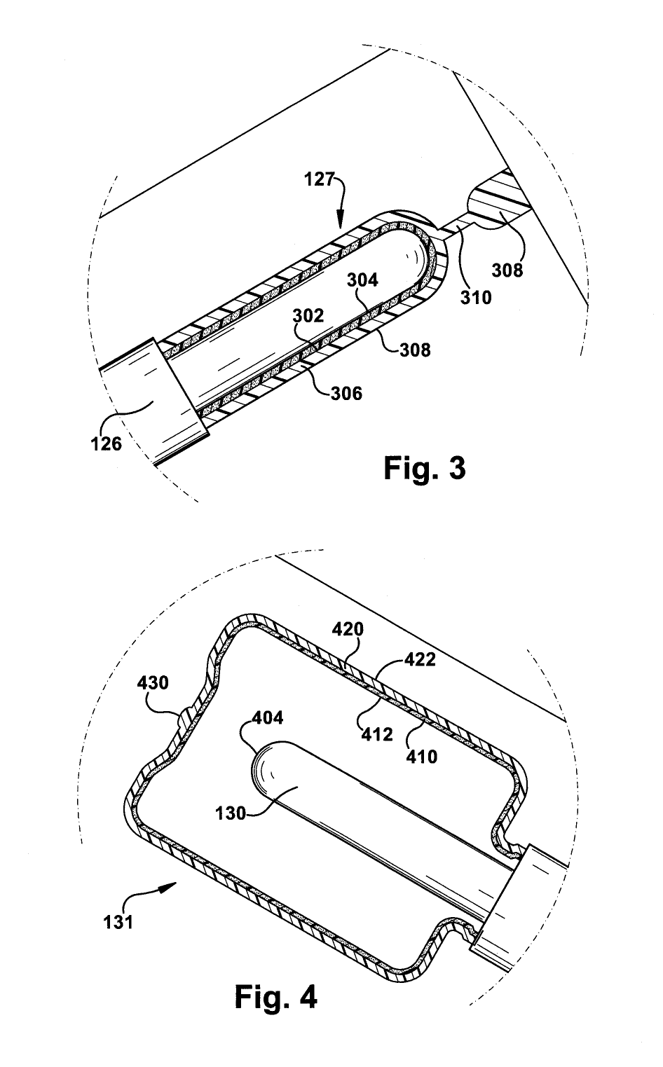

FIG. 3 is an expanded cross-sectional view of injection preform 127 shown in the injection molding station of FIG. 2. Injection preform 127 includes an inner layer 302 having an interior surface 304 and an outer layer 306 having an exterior surface 308. As described above, inner layer 302 is a sock preform originally placed on core pin 126 at the first, load station. Outer layer 306 is a molten polymer resin extruded from injection nozzle 308 of barrel 144 (FIGS. 1 and 2) and through runner 310 of mold cavity 156 (FIG. 1) to surround inner layer 302 or sock preform to produce the injection preform 127. The molten resin that forms the exterior surface 308 of outer layer 306 is a polymer composition that is different than the polymer composition of interior surface 304 of inner layer 302.

FIG. 4 is a cross-sectional view of hollow thermoplastic article 131 formed in the blow molding station of the injection blow molding apparatus 100 after having been advanced from the injection station. Gas, for example air, is blown through the tip 404 of core pin 130 to expand the inner and outer layers of what was initially an injection preform against blow mold cavity 167 (FIG. 1). A hollow thermoplastic article is thereby produced having an inner layer 410 having an interior surface 412 and an outer layer 420 having an exterior surface 422. The exterior surface 422 of outer layer 420 is a polymer composition that is different than the polymer composition of interior surface 412 of inner layer 410. Advantageously, the inner layer is blown in the outer layer and the pressure of blow molding can tightly bond the two layers.

The hollow thermoplastic articles produced, for example article 131, can have more than two layers. That is, each of the inner and outer layers 410, 420, or both, can be multi-layered. For example, sock preform which makes up the inner layer 304 of injection preform can be multi-layered and the outer layer of injection preform can be multi-layered. The outer layer can be multi-layered produced via co-injection molding at the injection molding station. For example, two different materials can be melted in separate injection barrels and flow through separate runner systems to the mold. The polymer first injected sets up on the inside surfaces of the mold cavity and also on the surface of the sock preform disposed between the upper and lower mold cavity. When a second molten polymer is injected, it flows between the layer of the first molten polymer surrounding the sock preform and eventually becomes a middle layer of the hollow article, and the second molten polymer surrounding the mold cavity surfaces, becomes the outer layer of the injection preform, and ultimately, the outer layer of hollow article formed during blow molding. The compositions of two or more of the multiple layers can be the same, so long as the material compositions of interior surface and exterior surface of injection preform that ultimately become the interior and exterior surfaces of the hollow article are different compositions.

The processes described above can further include forming the sock preform prior to loading the sock preform on the core pins, for example sock preform 111 of FIG. 1. The sock preform can be formed by one of several different methods. In one example embodiment, a sheet or film of thermoplastic material can be placed over a form, having one or more protrusions optionally shaped substantially similar to the core pin. The sheet or film can then be vacuumed formed or thermal formed, for example, to produce the sock preform. The sock preform can also be an injection molded part produced in an injection molding operation, well know to those of ordinary skill in the art. The shape of the sock preform can be substantially cylindrical to facilitate even coverage during injection molding and to achieve substantially equal stress distribution throughout the preform during blow molding, however, alternative shapes, such as, rectangular shapes, are possible.

As stated above, the sock preform can have two or more layers of different material compositions made from a multi-layer sheet or film used during forming. An additional layer in the sheet or film can serve as a tie layer that provides for better adhesion of the molten polymer that is injected onto the sock preform during the injection state. In some cases, the inner layer and the outer layer materials are not compatible at the interface surface and therefore do not adhere well to one another. In such case, a tie layer may be added which is compatible with both the inner and outer layers. In this manner, one of the layers of the sheet or film used to make the sock preform is a material composition having a surface that will be placed into contact with the core pin 111 at the first station of the injection molding apparatus 100 as described above.

Additional layers of the sheet or film can provide additional physical or aesthetic properties, including those of a tie-layer, which are not necessarily required at the internal and external surfaces of the hollow thermoplastic article ultimately produced, and therefore surface management of the internal and external surfaces of the resulting hollow article, a bottle, a container, etc., can be achieved. Bottle 131 appears in FIG. 4 as having two layers, an inside layer and an outside layer, although each of those layers may be made of several layers of material of different composition. Several desirable properties can be obtained by compensating the properties of the layers with the other; for example, the outer layer may be made of a relatively hard material to impart scratch hardness of the bottle surface, whereas the inner layer may be hemo-compatible, for example.

Aesthetic features of the hollow article can also be achieved. For example, the inner and outer layers, as well as any middle layers, may be of a different color. Referring to FIG. 4, in another embodiment, inner layer 410 may extend along only a portion of the hollow thermoplastic article 131. That is, the inner layer 410 may extend along only a portion of outer layer 420. In such case, the sock preform 111 (FIG. 1) would extend along only a portion of core rod 110, for example, thereby producing a hollow thermoplastic article in which only a portion of the thermoplastic article has an interior surface that is different than the exterior surface. In such case the inner layer 410 may be useful as an identifier or tag on the article 131. Alternatively, the outer layer 420 may extend along only a portion of the inner layer 410, for example, by injection molding outer layer 306 (FIG. 3) along a portion of inner layer 302 during the injection molding stage. As shown in FIG. 4, a nub or vestige 430 remains on the exterior surface 422 of hollow article 131 which remains from the runner, for example runner 310, formed during the injection molding stage. Aside from the vestige 430, the hollow thermoplastic article 131 can be otherwise substantially seamless.

Any combinations of materials may be used for the inner layer and outer layer materials as far as they behave like a thermoplastic in undergoing blow molding. Material compositions can include, but are not limited to, polyesters, polycarbonates, polycarbonate-based copolymers; polyesters, such as, for example, amorphous polyester terephthalate (APET), poly(ethylene terephthalate) (PET), poly(propylene terephthalate), poly(butylenes terephthalate) (PBT), poly(clyclohexane dimethanol cyclohexane dicarboxylate), and glycol-modified polyethylene terepthalate (PETG); polyvinylchloride (PVC); polysulfones, including polyethersulfone (PES), and polyphenylsulfone (PPSU); poly(vinyl acetate); polyarylates; polyetherimide (PEI); polyimide; polyamide; polyestercarbonates; polyetherketone; polyolefins, for example, polypropylene, and polyethylene; and polyurethanes. The thicknesses of the inner and outer layers 410, 420 can vary depending upon the desired characteristics of the hollow article. For example, the type of process and material used in forming the sock preform will often dictate the thickness of the inner layer. For example, a thermoformed, sock preform may have a thinner wall thickness than an injection-molded sock preform. Very thin films may be used as the sock preform and both the inner and outer walls 302, 304 of preform 126, for example, will typically shrink in thickness during the blow molding stage. Thus the thickness of inner layer 410 of a completed hollow article 131, can range from 0.1 millimeters to 10 millimeters, in alternative embodiment, from 0.5 millimeter to 1.5 millimeter, and in yet another embodiment from 0.8 millimeters to 1.2 millimeters. Likewise, thin wall thicknesses for the outer layer 304 can be produced by injecting molding molten polymer around the inner layer of sock perform to produce an injection preform. The inner layer 410 (FIG. 4) is likewise stretched during blow molding to produce an outer layer having the same wall thickness ranges as the outer layer 420.

In another embodiment, additional stations of the injection molding apparatus 100 can present to allow for additional processing steps. For example, the injection molded preform can advance to a conditioning station before advancing to the blow molding station. In such case the injection molded preform is allowed to cool and is then re-heated prior to blow molding. The conditioning stage can allow for a more even temperature distribution of the injection-molded preform before blow molding. Conditioning steps are optional and can depend upon a variety of factors, for example, the geometry of the part, the wall thicknesses and the thermoplastic materials used, as will be appreciated by those of ordinary skill in the art.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A process for making a hollow thermoplastic article comprising the steps of:
placing a sock preform comprising a first material composition about a core pin;
injection molding a molten parison comprising a second material composition which is different than the first material composition, into an injection mold cavity about the sock preform to produce an injection preform having an inner layer of the first material composition and an outer layer of the second material composition; and
blow molding the injection preform to produce a hollow thermoplastic article comprising an interior surface of the first material composition and an external surface of the second material composition.

2. The process of claim 1, further comprising the step of ejecting the hollow thermoplastic article from the core pin.

3. The process of claim 1, wherein the first material composition and the second material composition are different in molecular structure.

4. The process of claim 1, wherein the first material composition and the second material composition are different in color.

5. The process of claim 1, wherein the first material composition and the second material composition have the same molecular structure.

6. The process of claim 1, further comprising the step of forming thermoplastic to produce a sock preform prior to loading the sock perform on the core pin.

7. The process of claim 6, wherein the step of forming comprises injection molding thermoplastic resin.

8. The process of claim 6, wherein the step of forming comprises forming a sheet of thermoplastic.

9. The process of claim 8, wherein the sheet is formed by vacuum forming.

10. The process of claim 8, wherein the sheet is formed by thermoforming.

11. The process of claim 8, wherein the sheet of thermoplastic is multi-layer sheet of at least two layers, and the material composition of the at least two layers are different.

12. The process of claim 1, further comprising:
injection molding a molten parison comprising a third material composition different than the second material composition into the injection mold cavity after injection molding the molten parison comprising the second material composition to produce an injection preform comprising a third layer of the third material composition between the inner layer of the first material composition and the outer layer of the second material composition.

13. The process of claim 1, wherein the summation of time required for the steps of loading and ejecting is less than the time required for injecting the molten parison comprising the second material.

14. The process of claim 1, further comprising the step of heating the injection preform prior to blow molding the injection preform.

15. The process of claim 1, wherein:
the steps of loading, injection molding and blow molding are performed on a injection blow molding apparatus at a first station, a second station, and a third station, respectively; and
the process further comprises:
moving the core pin from the first station to the second station after receiving the sock preform of the first material composition, and moving a second core pin from the second station to the third station after the second material composition is injection molded onto the sock preform.

16. The process of claim 15, further comprising moving a third core pin from the third station to the first station after blow molding.

17. The process of claim 16, further comprising ejecting the hollow thermoplastic article from a third core pin at the first station.

18. The process of claim 17, further comprising placing a second sock preform onto the third core pin at the first station after ejecting the hollow thermoplastic article from the core pin.

19. A process for injection blow molding a plurality of hollow thermoplastic articles, the process comprising the steps of:
loading a sock preform of a first material composition onto a first core pin;
injection molding a molten parison of a second material composition onto a second core sock of the first material composition and supported by a second core pin;
blow molding an injection preform comprising an inner layer of the first material composition and an outer layer of the second material composition, the preform being supported by a third core pin; and
wherein at least a portion of each step is carried out simultaneously.

20. The process of claim 19, further comprising:
ejecting a hollow thermoplastic article from the first core pin prior to placing the sock perform onto the first core pin; and
wherein at least a portion of the ejecting, injection molding, and blow molding steps are carried out simultaneously.

21. The process of claim 18, wherein the steps of loading, injection molding and blow molding are performed on a injection blow molding apparatus at a first station, a second station, and a third station, respectively.

22. The process of claim 21, further comprising:
moving the first core pin from the first station to a position previously occupied by the second core pin at the second station after receiving the sock perform of the first material composition;
moving the second core pin from the second station to a position previously occupied by the third core pin at the third station after the second material composition is injection molded onto the sock preform.

23. The process of claim 22, further comprising:
moving the third core pin from the third station to a position previously occupied by the first core pin at the first station after blow molding.

24. The process of claim 23, wherein the third core pin moves to the first station; and
ejecting a hollow thermoplastic article from the first core pin at the first station.

25. The process of claim 21, wherein the first core pin, second core pin, and third core pin reside at each of the first station, the second station and the third station for the same period of time.

26. The process of claim 19, further comprising the step of forming thermoplastic to produce a sock preform prior to loading the sock perform on the core pin.

27. A hollow thermoplastic article comprising:
an interior surface of an inner layer comprising a first material composition;
an exterior surface of an outer layer comprising a second material composition different than the first material composition; and
wherein at least one of the inner layer and outer layer extends along a portion of the hollow thermoplastic article.

28. The hollow thermoplastic article of claim 27, wherein the hollow thermoplastic article made by injection blow molding.

29. The hollow thermoplastic article of claim 27, wherein the hollow thermoplastic article is a bottle.

30. The hollow thermoplastic article of claim 27, wherein the inner layer extends along a portion of the outer layer of the hollow thermoplastic article.

31. The hollow thermoplastic article of claim 27, wherein the thickness of the inner layer ranges from 0.1 millimeters to 10 millimeters, and the thickness of the outer layer ranges from 0.1 millimeters to 10 millimeters.

32. A hollow thermoplastic article comprising:
an interior surface formed by an inner layer of a first material composition;
an exterior surface formed by an outer layer of a second material composition different than the first material composition; and
wherein the outside surface of the hollow thermoplastic article comprises a vestige and the outside surface is otherwise substantially seamless.
